(19) United States
(12) Patent Application Publication
(10) Pub. No.: US 2024/0177013 A1
(43) Pub. Date: May 30, 2024

(54) MACHINE-LEARNING MODEL THAT RECOMMENDS VIRTUAL EXPERIENCES BASED ON GRAPHS AND CLUSTERING

(71) Applicant: Roblox Corporation, San Mateo, CA (US)

(72) Inventors: Xiaohong GONG, Sunnyvale, CA (US); Nemanja PETROVIC, Belgrade (RS); Shervin SHAHIDI, Foster City, CA (US); Nipun PARASRAMPURIA, San Francisco, CA (US); Nishanth Rao Palimar RAGHUPATHI, Castro Valley, CA (US); Xusheng SUN, Sunnyvale, CA (US)

(73) Assignee: Roblox Corporation, San Mateo, CA (US)

(21) Appl. No.: 18/071,341

(22) Filed: Nov. 29, 2022

(51) Int. Cl. G06N 3/091; G06F 9/451

(52) U.S. Cl. CPC G06N 3/091; G06F 9/451

(57) ABSTRACT

A computer-implemented method to train a machine-learning model to recommend virtual experiences to a user. The method includes receiving training data that includes pairs of users and virtual experiences, wherein each user of a pair is associated with user features, each virtual experience of the pair is associated with item features, and each pair includes a virtual experience that a corresponding user interacted with. The method further includes training a user tower of the machine-learning model by: generating first feature embeddings based on the user features in the training data and training a first deep neural network (DNN) to output user embeddings based on the first feature embeddings. The method further includes training an item tower of the machine-learning model by: generating second feature embeddings based on the item features in the training data and training a second DNN to output item embeddings based on the second feature embeddings.

### BACKGROUND

Recommendation systems are excellent at recommending experiences to users when information is known about the users and when information is known about the experiences. The recommendation systems may include high-level representations from labeled data with layered differentiable models. However, the recommendation systems are often inefficient, the data lacks robustness, and/or the data is not generalizable.

For example, a recommendation system receives a query and retrieves the top K-most relevant items from among millions or billions of available items. The quality of the retrieval model relies on the quality of learned query representation and item representation. For well-trained query representations or item representations, similar queries and items should be closer in the embedding space. Similarly, the quality of a ranking system that ranks the top K-most relevant items also relies on learning embedding representations of critical sparse features.

Training deep supervised models typically requires large amounts of data and labels due to the large number of parameters of such deep models. Learning good representations becomes difficult when there are insufficient training data/labels or if feature distributions are highly skewed. As a result, it is difficult to generate recommendations for a brand-new user or for a brand-new experience.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Embodiments relate generally to a method to train a machine-learning model to recommend virtual experiences to a user. The method includes receiving training data that includes pairs of users and virtual experiences, wherein each user of a pair is associated with user features, each virtual experience of the pair is associated with item features, and each pair includes a virtual experience that a corresponding user interacted with. The method further includes training a user tower of the machine-learning model by: generating first feature embeddings based on the user features in the training data and training a first deep neural network (DNN) to output user embeddings based on the first feature embeddings. The method further includes training an item tower of the machine-learning model by: generating second feature embeddings based on the item features in the training data and training a second DNN to output item embeddings based on the second feature embeddings, where training the user tower or the item tower of the machine-learning model includes generating one or more graphs that are used to recommend one or more virtual experiences to a user.

In some embodiments, training the user tower or the item tower of the machine-learning model includes generating a user-experience-experience graph that is formed by: generating edges between user nodes and virtual experience nodes based on users associated with the user nodes interacting with the virtual experiences associated with the virtual experience nodes, wherein the edges between the user nodes and the virtual experience nodes are based on user affinity and generating edges between the virtual experience nodes based on one or more users playing two corresponding virtual experience nodes, wherein the edges between the virtual experience nodes are based on a number of a number of same user actions performed between the two corresponding virtual experience nodes. In some embodiments, the method further includes determining a predicted traversal of the user-experience-experience graph using a random walk algorithm or a Personalized PageRank algorithm. In some embodiments, training the item tower of the machine-learning model further includes generating item clusters from the item embeddings by: generating edges between user nodes and virtual experience nodes based on users associated with the user nodes interacting with the virtual experiences associated with the virtual experience nodes, wherein the edges between the user nodes and the virtual experience nodes are based on user affinity, retrieving one or more virtual experiences with limited user engagement, and generating the item clusters from the one or more virtual experiences with limited user engagement and corresponding item embeddings based on similarity between the one or more virtual experiences with limited user engagement and the corresponding item embeddings. In some embodiments, the machine-learning model is a first machine-learning model and further comprising training a second machine-learning model to rank a subset of the candidate virtual experiences to recommend to a user, wherein training the second machine-learning model is based on the item clusters. In some embodiments, training the user tower or the item tower of the machine-learning model includes generating a users-users-experience graph that is formed by: generating edges between user nodes and virtual experience nodes based on users associated with the user nodes interacting with the virtual experiences associated with the virtual experience nodes, wherein the edges between the user nodes and the virtual experience nodes are based on user affinity and generating edges between the user nodes based on users corresponding to the user nodes interacting with one or more same two virtual experiences, wherein the edges between the users are based on a number of same user actions performed between the two corresponding user nodes. In some embodiments, training the user tower of the machine-learning model further includes generating user clusters from the user embeddings by: generating edges between user nodes and virtual experience nodes based on users associated with the user nodes interacting with the virtual experiences associated with the virtual experience nodes, wherein the edges between the user nodes and the virtual experience nodes are based on user affinity, retrieving one or more users, and generating the user clusters from the one or more users and corresponding item embeddings based on similarities between the one or more users and the corresponding item embeddings. In some embodiments, the machine-learning model is a first machine-learning model and further comprising training a second machine-learning model to rank a subset of the candidate virtual experiences to recommend to a user, wherein training the second machine-learning model is based on the user clusters. In some embodiments, training the second machine-learning model includes generating feature embeddings from the item features, the user features, the item clusters, and the user clusters and training a third DNN based on the feature embeddings. In some embodiments, the user embeddings and the item embeddings are generated offline.

According to one aspect, a device includes a processor and a memory coupled to the processor, with instructions stored thereon that, when executed by the processor, cause the processor to perform operations comprising: the machine-learning model is a first machine-learning model and further comprising:

In some embodiments, a computer implemented method to recommend a ranked set of virtual experiences to a user includes: receiving, with a first machine-learning model, training data that includes pairs of users and virtual experiences, wherein each user of a pair is associated with user features, each virtual experience of the pair is associated with item features, and each pair includes a virtual experience that a corresponding user interacted with; training a user tower of the first machine-learning model by: training a first deep neural network (DNN) to output user embeddings; and generating user clusters from the user embeddings based on a distance between each of the user embeddings; training an item tower of the first machine-learning model by: training a second DNN to output item embeddings; and generating item clusters from the item embeddings based on a distance between each of the item embeddings; wherein the first machine-learning model is trained to generate candidate virtual experiences for a user; and training a second machine-learning model to recommend a ranked set of virtual experiences to a user by: receiving the user clusters and the item clusters from the second machine-learning model; generating feature embeddings based on item features, user features, the user clusters, and the item clusters; and training a third DNN to output a ranked subset of the candidate virtual experiences based on the feature embeddings.

In some embodiments, the user clusters are further based on: generating edges between user nodes and virtual experience nodes based on users associated with the user nodes interacting with the virtual experiences associated with the virtual experience nodes, wherein the edges between the user nodes and the virtual experience nodes are based on user affinity and retrieving one or more virtual experiences with limited user engagement, where the user clusters include corresponding user embeddings based on similarity between the user embeddings. In some embodiments, the item clusters are further based on: generating edges between user nodes and virtual experience nodes based on users associated with the user nodes interacting with the virtual experiences associated with the virtual experience nodes, wherein the edges between the user nodes and the virtual experience nodes are based on user affinity and retrieving one or more virtual experiences with limited user engagement, where the item clusters include the one or more virtual experiences with limited user engagement and corresponding item embeddings based on similarity between the one or more virtual experiences with limited user engagement and the corresponding item embeddings. In some embodiments, training the user tower or the item tower of the first machine-learning model includes generating a users-users-experience graph that is formed by: generating edges between user nodes and virtual experience nodes based on users associated with the user nodes interacting with the virtual experiences associated with the virtual experience nodes, wherein the edges between the user nodes and the virtual experience nodes are based on user affinity and generating edges between the user nodes based on users corresponding to the user nodes interacting with one or more same two virtual experiences, wherein the edges between the users are based on a number of same user actions performed between the two corresponding user nodes.

A recommendation system comprises: one or more processors; and a memory coupled to the one or more processors, with instructions stored thereon that, when executed by the one or more processors, cause the one or more processors to perform operations including: providing user features to a trained neural network including an item tower and a user tower, wherein the user features include a past user interaction history with one or more virtual experiences, outputting, with the trained neural network, candidate virtual experiences that are based on the user features, user clusters, and item clusters, providing the candidate virtual experiences as input to a trained ranking model, wherein the trained ranking model is trained based on the user clusters and the item clusters associated with the trained neural network, and outputting, with the trained ranking model, a ranked subset of the candidate virtual experiences.

In some embodiments, the operations further include receiving a query that includes the user features and generating user vectors based on the user features, wherein outputting the candidate virtual experiences includes performing a nearest-neighbor search of the user vectors to the item clusters. In some embodiments, the item clusters include the one or more virtual experiences with limited user engagement and corresponding item embeddings based on similarity between the one or more virtual experiences with limited user engagement and the corresponding item embeddings. In some embodiments, the operations further include: receiving a query that includes the user features associated with a user and determining a similarity between the user features and cluster identifiers, wherein outputting the ranked subset of the candidate virtual experiences is based on the cluster identifiers. In some embodiments, the cluster identifiers represent a past interaction history of the user

The application advantageously describes a metaverse engine that trains a machine-learning model to recommend virtual experiences to a user with limited experience history or recommends new virtual experiences with limited interaction histories to a user.

### BRIEF DESCRIPTION OF THE DRAWINGS

FIG. 1 is a block diagram of an example network environment to train a machine-learning model to recommend virtual experiences to users, according to some embodiments described herein.

FIG. 2 is a block diagram of an example computing device to train a machine-learning model to recommend virtual experiences to users, according to some embodiments described herein.

FIG. 3 is a block diagram of an example process to recommend virtual experiences to a user, according to some embodiments described herein.

FIG. 4 is a block diagram of an example architecture for the candidate generator module to generate candidate virtual experiences, according to some embodiments described herein.

FIG. 5 is a block diagram of an example user-experience-experience graph, according to some embodiments described herein.

FIG. 6 is a block diagram of example item clusters based on item embeddings, according to some embodiments described herein.

FIG. 7 is a block diagram of an example users-users-experience graph, according to some embodiments described herein.

FIG. 8 is a block diagram of example user clusters based on user embeddings, according to some embodiments described herein.

FIG. 9 is a block diagram of an example architecture of the candidate ranker module to rank the candidate virtual experiences, according to some embodiments described herein.

FIG. 10 is a block diagram of example item clustering, according to some embodiments described herein.

FIG. 11 is a flow diagram of an example method to train a machine-learning model to recommend virtual experiences, according to some embodiments described herein.

FIG. 12 is a flow diagram of an example method to train a first machine-learning model to recommend virtual experiences and to train a second machine-learning model to rank the virtual experiences, according to some embodiments described herein.

FIG. 13 is a flow diagram of an example method to provide a ranked set of virtual experiences to a user, according to some embodiments described herein.

### DETAILED DESCRIPTION

Network Environment 100

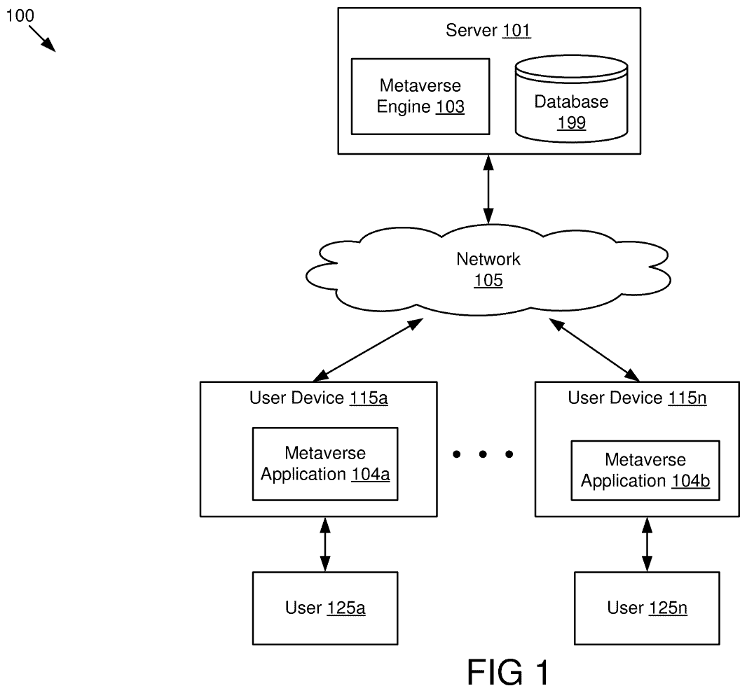

FIG. 1 illustrates a block diagram of an example environment 100 to train a machine-learning model to recommend virtual experiences to users. In some embodiments, the environment 100 includes a server 101, user devices 115a . . . n, and a network 105. Users 125a . . . n may be associated with the respective user devices 115a . . . n. In FIG. 1 and the remaining figures, a letter after a reference number, e.g., “115a,” represents a reference to the element having that particular reference number. A reference number in the text without a following letter, e.g., “115,” represents a general reference to embodiments of the element bearing that reference number. In some embodiments, the environment 100 may include other servers or devices not shown in FIG. 1. For example, the server 101 may be multiple servers 101.

The server 101 includes one or more servers that each include a processor, a memory, and network communication hardware. In some embodiments, the server 101 is a hardware server. The server 101 is communicatively coupled to the network 105. In some embodiments, the server 101 sends and receives data to and from the user devices 115. The server 101 may include a metaverse engine 103 and a database 199.

In some embodiments, the metaverse engine 103 includes code and routines operable to receive communications between two or more users in a virtual metaverse, for example, at a same location in the metaverse, within a same metaverse experience, or between friends within a metaverse application. The users interact within the metaverse across different demographics (e.g., different ages, regions, languages, etc.).

In some embodiments, the metaverse engine 103 receives training data that includes pairs of users and virtual experiences, wherein each user of a pair is associated with user features, each virtual experience of the pair is associated with item features, and each pair includes a virtual experience that a corresponding user interacted with. The metaverse engine 103 trains a user tower of the machine-learning model by: generating feature embeddings based on the user features in the training data and training a first deep neural network (DNN) to output user embeddings based on the feature embeddings. The metaverse engine 103 trains an item tower of the machine-learning model by: generating feature embeddings based on the item features in the training data and training a second DNN to output item embeddings based on the feature embeddings, where the item embeddings or the user embeddings include one or more graphs that associate users with experiences.

In some embodiments, the metaverse engine 103 is implemented using hardware including a central processing unit (CPU), a field-programmable gate array (FPGA), an application-specific integrated circuit (ASIC), any other type of processor, or a combination thereof. In some embodiments, the metaverse engine 103 is implemented using a combination of hardware and software.

The database 199 may be a non-transitory computer readable memory (e.g., random access memory), a cache, a drive (e.g., a hard drive), a flash drive, a database system, or another type of component or device capable of storing data. The database 199 may also include multiple storage components (e.g., multiple drives or multiple databases) that may also span multiple computing devices (e.g., multiple server computers). The database 199 may store data associated with the metaverse engine 103, such as training data sets for the trained machine-learning model, user actions and user features associated with each user 125, item features associated with each virtual experience, etc.

The user device 115 may be a computing device that includes a memory and a hardware processor. For example, the user device 115 may include a mobile device, a tablet computer, a mobile telephone, a wearable device, a head-mounted display, a mobile email device, a portable game player, a portable music player, or another electronic device capable of accessing a network 105.

User device 115a includes metaverse application 104a and user device 115n includes metaverse application 104n, respectively. In some embodiments, the metaverse application 104 on a user device 115 receives one or more recommended virtual experiences from the metaverse engine 103 on the server 101. The metaverse application 104 generates a user interface that displays the one or more recommended virtual experiences to the user 125.

In the illustrated embodiment, the entities of the environment 100 are communicatively coupled via a network 105. The network 105 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof. Although FIG. 1 illustrates one network 105 coupled to the server 101 and the user devices 115, in practice one or more networks 105 may be coupled to these entities.

Computing Device Example 200

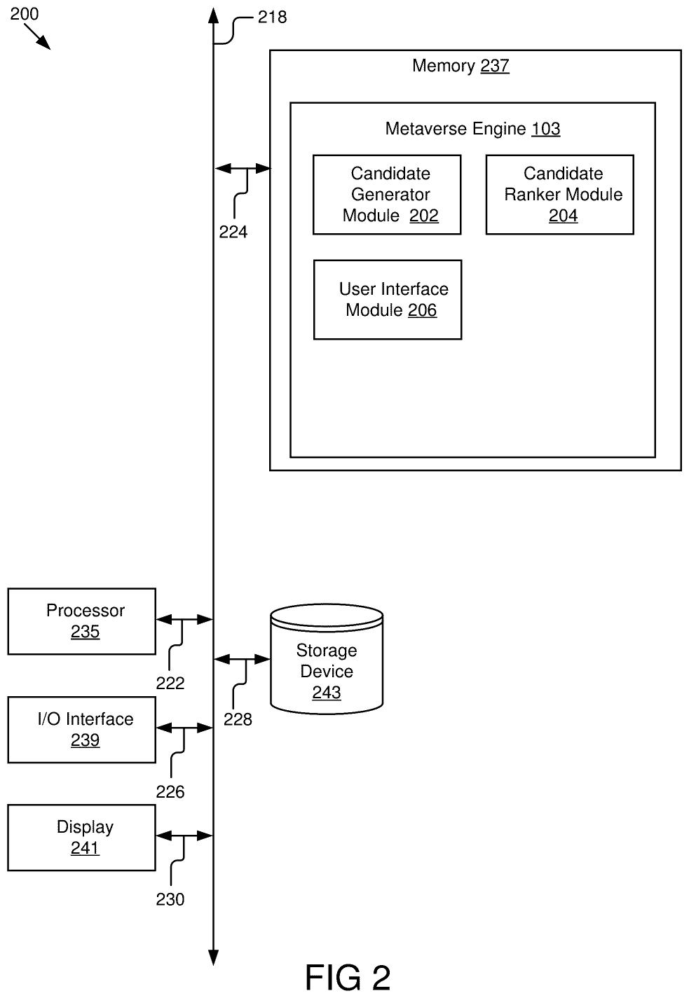

FIG. 2 is a block diagram of an example computing device 200 that may be used to implement one or more features described herein. Computing device 200 can be any suitable computer system, server, or other electronic or hardware device. In some embodiments, computing device 200 is the server 101. In some embodiments, the computing device 200 is the user device 115.

In some embodiments, computing device 200 includes a processor 235, a memory 237, an Input/Output (I/O) interface 239, a display 241, and a storage device 243. Depending on whether the computing device 200 is the server 101 or the user device 115, some components of the computing device 200 may not be present. For example, in instances where the computing device 200 is the server 101, the computing device may not include the display 241. In some embodiments, the computing device 200 includes additional components not illustrated in FIG. 2.

The processor 235 may be coupled to a bus 218 via signal line 222, the memory 237 may be coupled to the bus 218 via signal line 224, the I/O interface 239 may be coupled to the bus 218 via signal line 226, the display 241 may be coupled to the bus 218 via signal line 230, and the storage device 243 may be coupled to the bus 218 via signal line 228.

The processor 235 includes an arithmetic logic unit, a microprocessor, a general-purpose controller, or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. Although FIG. 2 illustrates a single processor 235, multiple processors 235 may be included. In different embodiments, processor 235 may be a single-core processor or a multicore processor. Other processors (e.g., graphics processing units), operating systems, sensors, displays, and/or physical configurations may be part of the computing device 200.

The memory 237 stores instructions that may be executed by the processor 235 and/or data. The instructions may include code and/or routines for performing the techniques described herein. The memory 237 may be a dynamic random access memory (DRAM) device, a static RAM, or some other memory device. In some embodiments, the memory 237 also includes a non-volatile memory, such as a static random access memory (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the metaverse engine 103, which is described in greater detail below.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 243), and input/output devices can communicate via I/O interface 239. In another example, the I/O interface 239 can receive data from user device 115 and deliver the data to the metaverse engine 103 and components of the metaverse engine 103, such as the candidate generator module 202. In some embodiments, the I/O interface 239 can connect to interface devices such as input devices (keyboard, pointing device, touchscreen, microphone, sensors, etc.) and/or output devices (display devices, speakers, monitors, etc.).

Some examples of interfaced devices that can connect to I/O interface 239 can include a display 241 that can be used to display content, e.g., images, video, and/or a user interface of an output application as described herein, and to receive touch (or gesture) input from a user. Display 241 can include any suitable display device such as a liquid crystal display (LCD), light emitting diode (LED), or plasma display screen, cathode ray tube (CRT), television, monitor, touchscreen, three-dimensional display screen, or other visual display device.

The storage device 243 stores data related to the metaverse engine 103. For example, the storage device 243 may store training data sets for the trained machine-learning model user actions and user features associated with each user 125, item features associated with each virtual experience, etc. In embodiments where the computing device 200 is the server 101, the storage device 243 is the same as the database 199 in FIG. 1.

Example Metaverse Engine 103 or Metaverse Application 104

FIG. 2 illustrates a computing device 200 that executes an example metaverse engine 103 that includes a candidate generator module 202, a candidate ranker module 204, and a user interface module 206.

The candidate generator module 202 determines candidate virtual experiences for a particular user. In some embodiments, the candidate generator module 202 includes a set of instructions executable by the processor 235 to determine the candidate virtual experiences. In some embodiments, the candidate generator module 202 is stored in the memory 237 of the computing device 200 and can be accessible and executable by the processor 235.

In some embodiments, the candidate generator module 202 determines candidate virtual experiences for a user. The virtual experiences may include any type of event that may be experienced by a user. For example, the virtual experience may be a game that a user plays, a movie that a user watches, an article that a user reads, a virtual concert or meeting that a user attends, etc.

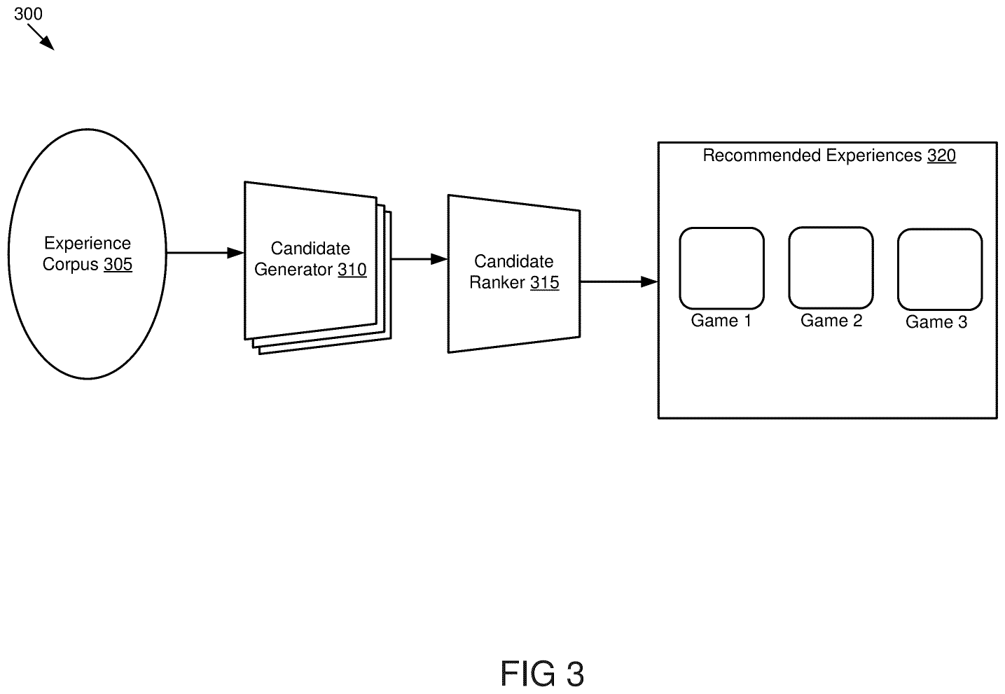

In some embodiments, the process for recommending virtual experiences is broken into four stages. FIG. 3 is a block diagram 300 of an example process to recommend virtual experiences to a user. In this example, the process is divided into an experience corpus 305, candidate generators 310, a candidate ranker 315, and recommended experiences 320. The experience corpus 305 includes all the virtual experiences available to a user. The experience corpus 305 may include hundreds of thousands or even millions of virtual experiences. In some embodiments, the multiple candidate generators 310 include a different module for each type of graph discussed in greater detail below. The one or more candidate generators 310 retrieve the top K virtual experiences from the experience corpus 305. The candidate ranker 315 ranks the top K virtual experiences based on the user's own interests, history, and context, and outputs the top N virtual experiences. The top N virtual experiences are then displayed to the user, for example, by transmitting graphical data for displaying the top N virtual experiences from the server 101 to a user device 115.

In some embodiments, both the candidate generator 310 and the candidate ranker 315 include deep neural network (DNN) models that include layers that identify increasingly more detailed features and patterns about the different embeddings where the output of one layer serves as input to a subsequent layer. Training DNNs may involve using large sets of labeled training data due to the large number of parameters that are part of the DNNs. Specifically, the DNNs generate embeddings that are improved by larger training data sets. Otherwise, the DNNs may overly rely on highly skewed data.

A user may be described by user features and a virtual experience may be described by item features. User features may include, for example, demographic information for a user (location, gender, age, etc.), user interaction history (e.g., duration of interaction with a virtual experience, clicks during the interaction, money spent during the interaction, etc.), context features (e.g., device identifier, an internet protocol (IP) address for the client device, country), user identifiers (ID) for people that the user plays with, etc. The item features may include a universe ID (i.e., the unique identifier for a virtual experience, such as a game), the daily active users (DAU) (i.e., the number of active users that interact with the virtual experience in the past predetermined number of days), an identification of a developer of the virtual experience, how many developer items are in the virtual experience, the release date for the virtual experience, etc.

The candidate generator 310 and the candidate ranker 315 are trained with user features and item features. For example, the candidate generator 310 may be a two-tower model that generates user embeddings and item embeddings and compares the user embeddings and item embeddings to each other to generate the candidate virtual experiences. As a result, the training data includes original training examples corresponding to a set of virtual experiences, where individual training examples comprise user features and item features. The candidate ranker 315 is trained with different user features and item features than the candidate generator 310. For example, both sets of training data are labeled with different items because the goals for training the candidate generator 310 and the candidate ranker 315 are different.

In some embodiments, the candidate generator module 202 trains a machine-learning model to identify candidate virtual experiences. The candidate generator module 202 receives training data that includes pairs of users and virtual experiences, where each user of a pair is associated with user features and each virtual experience of the pair is associated with item features. For example, a user interacts with the virtual experience by playing with other users, purchasing items in the game, playing for a particular duration, playing at 3 am, etc. Those interactions are the user features.

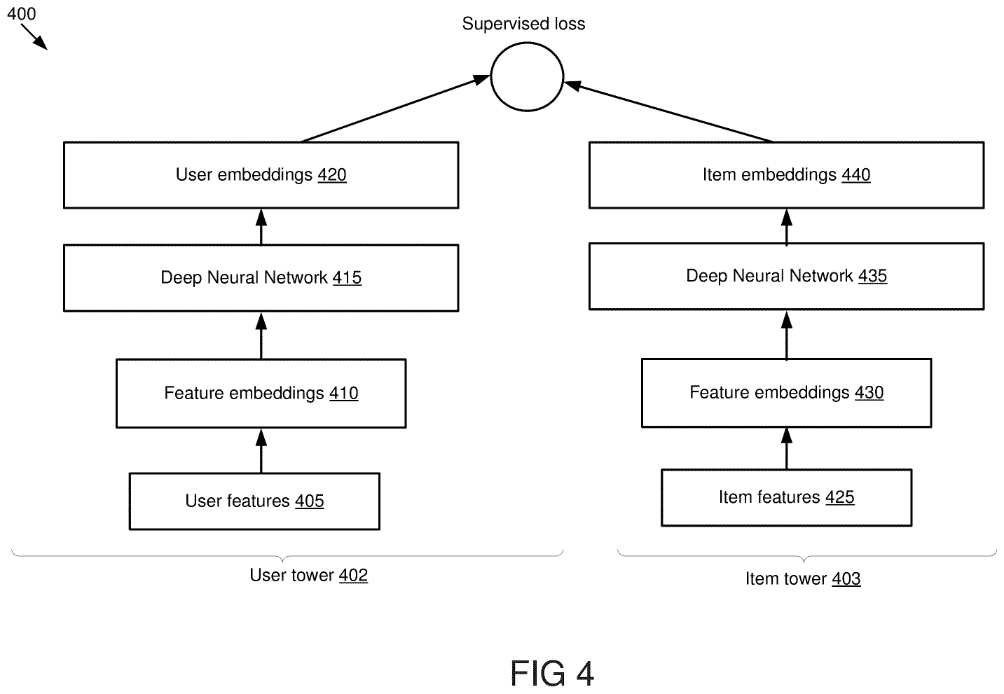

FIG. 4 is a block diagram of an example architecture 400 for the candidate generator module 202 to generate candidate virtual experiences. The example architecture 400 is a two-tower model made that includes a user tower 402 and an item tower 403. The two-tower model means that the user features 405 and the item features 425 are learned separately, i.e., there is no cross learning between the user features 405 and the item features 425 in the hidden layers of a neural network. Instead, the user features 405 and the item features 425 use independent DNNs, 415, 435.

In some embodiments, the user tower 402 includes user features 405, feature embeddings 410, a DNN 415, and user embeddings 420. The user features 405 describe users' past interaction history with virtual experiences. The candidate generator module 202 generates feature embeddings 410 from the user features 405. The feature embeddings 410 are provided to the DNN 415 as input, which generates the user embeddings 420. The user embeddings 420 reflects the representations of user features 405 in the form of vectors that encode the user features 405 such that user features 405 that are closer in the vector space are expected to be more similar than user features 405 that are farther away. In some embodiments, the candidate generator module 202 clusters users based on a distance between the user embeddings 420. In some embodiments, the user embeddings 420 are generated offline.

The item tower 403 includes item features 425 that are converted into feature embeddings 430, which are provided as input to a DNN 435 and used to generate item embeddings 440. The item embeddings 440 reflect the representations of item features 425 in the form of vectors that encode the item features 425 such that item features 425 that are closer in the vector space are expected to be more similar than item features 425 that are farther away. In some embodiments, the item embeddings 440 are generated offline.

The candidate generator module 202 trains the two-tower model by determining a loss function for supervised loss. The supervised loss illustrated in FIG. 4 represents data that is positively labeled or negatively labeled based on user actions after the user interacts with a virtual experience (e.g., by purchasing an item, clicking on something during the interaction, etc.).

In some embodiments, the candidate generator module 202 generates one or more graphs associated with the user embeddings 420 and/or the item embeddings 440, such as a user-experience-experience graph or a users-users-games graph. In some embodiments, the candidate generator module 202 clusters the user embeddings 420 and/or the item embeddings 440 based on different parameters.

Through training, the two-tower model takes the training data of user-experience pairs and learns to associate user embeddings 420 with item embeddings 440. Once the machine-learning model is trained, the candidate generator module 202 retrieves virtual experiences with item embeddings 440 that are closest to the user embeddings 420 in order to identify candidate virtual experiences for the user. For example, the two-tower model may receive a user query with user features, generate user vectors based on the user features, and perform a nearest-neighbor search of the user vectors to the item embeddings 440 to compare the trained towers and identify candidate virtual experiences.

In some embodiments, the candidate generator module 202 generates one or more graphs based on item embeddings and/or user embeddings.

The candidate generator module 202 may generate user-experience-experience graphs based on item embeddings and types of interactions users have with a virtual experience. For example, the graph may be based on users that interact with a virtual experience at the same time (e.g., users that co-play a game together), users that spend money while interacting with virtual experiences, a duration of interacting with virtual experiences, a number of daily active users for different games, etc.

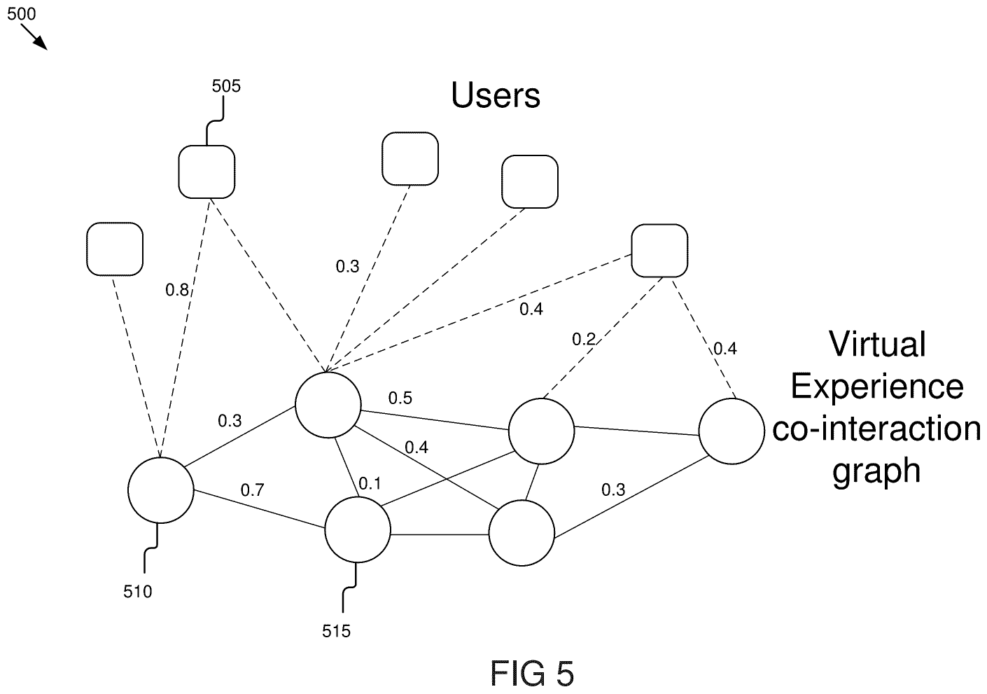

FIG. 5 is a block diagram 500 of an example user-experience-experience graph. The users in the graph are represented by squares, such as the square in node 505. The virtual experiences in the graph are represented by circles, such as node 510. When a user interacts with a virtual experience, the candidate generator module 202 generates an edge between the node representing the user and the node representing the virtual experience, which is illustrated with a dashed line in FIG. 5. When two virtual experiences are interacted with by the same user, the candidate generator module 202 adds an edge between the two corresponding nodes, which is illustrated with a solid line in FIG. 5.

The weights for the edges in the graph represent the strength between nodes, but the factors are different depending on the type of node. The edges between the virtual experiences reflect a number of same user actions that are performed between two corresponding virtual experience nodes. For example, the weights between virtual experiences may indicate how many users interacted with both virtual experiences, how long users interacted with both virtual experiences, etc. The edges between a user node and a virtual experience node reflects the user affinity (i.e., engagement) with respect to the virtual experience. For example, the weight may indicate how many times the user interacted with the virtual experience, how much money was spent while interacting with the virtual experience, how long the user interacted with the virtual experience, etc.

In some embodiments, the candidate generator module 202 generates the user-experience-experience graph based on a user's past interactions with virtual experiences. The candidate generator module 202 uses a probability algorithm to traverse a graph by moving from one node to another as long as the nodes are connected by a common edge. The candidate generator module 202 determine a likelihood that one node will be followed by a subsequent node based on the type of probability algorithm and the previous nodes visited during the traversal. For example, in a random walk, the candidate generator module 202 employs a Markov process to determine the probability that the traversal will randomly occur between a first node and a second node.

The candidate generator module 202 uses the weights in the graph to determine the probability that a particular user will interact with a virtual experience. For example, continuing with the example in FIG. 5, using the random walk algorithm there is a 70% chance that the user that corresponds to node 505 will move from the virtual experience that corresponds to node 510 to the virtual experience that corresponds to node 515 based on the 0.7 weight between the nodes 510, 515. Other traversal algorithms may be used, such as lazy random walk or Personalized PageRank (PPR).

In some embodiments, the candidate generator module 202 performs clustering of one or more virtual experiences with limited user engagement. This may include, for example, virtual experiences that have been in existence for less than a month, where users interacted with the virtual experience less than 100 times, etc. The candidate generator module 202 may retrieve the one or more virtual experience with limited user engagement and cluster the one or more virtual experiences with limited user engagement to a subset of virtual experiences based on similarities between corresponding item embeddings.

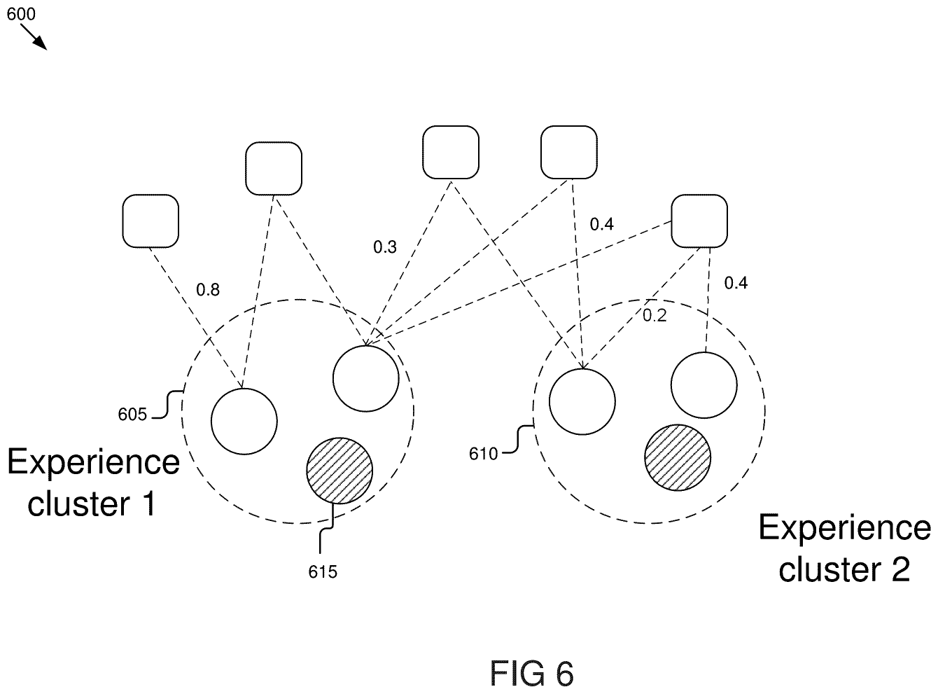

FIG. 6 is a block diagram 600 of example item clusters based on item embeddings. In this example, the candidate generator module 202 generates a graph of user nodes and virtual experience nodes based on users interacting with virtual experiences where the edges between the user nodes and the virtual experience nodes are based on user affinity.

In some embodiments, the candidate generator module 202 generates item clusters from virtual experience nodes based on the distances of item embeddings, which indicates a similarity between the virtual experience nodes. In some embodiments, due to the large size of the data set, the candidate generator module 202 generates the item clusters offline.

FIG. 6 illustrates the item embeddings as experience cluster 1 and experience cluster 2, as indicated by the dashed circles 605, 610. The candidate generator module 202 retrieves one or more virtual experiences with limited user engagement. Virtual experience node 615 represents a virtual experience with limited user engagement. In some embodiments, the candidate generator module 202 generates an item cluster that groups virtual experience node 615 in experience cluster 1 based on similarity in the item embeddings. As a result of the clustering, the candidate generator module 202 may recommend the virtual experience corresponding to virtual experience node 615 to users that receive other candidate virtual experiences from the same cluster.

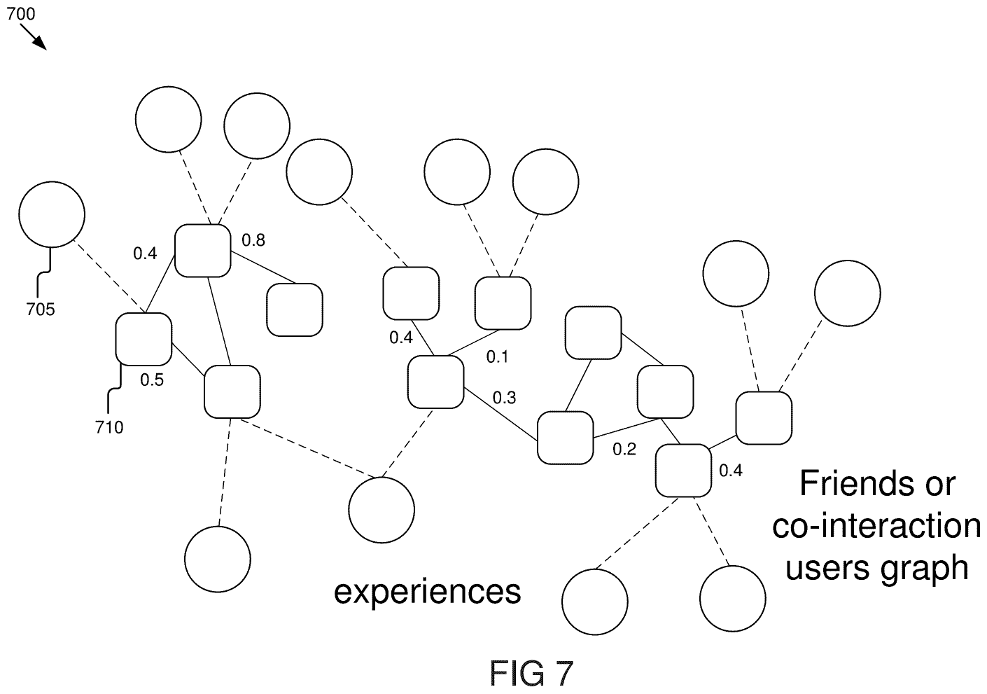

FIG. 7 is a block diagram 700 of an example users-users-experience graph. The virtual experiences in the graph are represented by circles, such as circle 705. The users in the graph are represented by squares, such as square 710. When a user interacts with a virtual experience, the candidate generator module 202 generates an edge between the node representing the user and the node representing the virtual experience, which is illustrated with a dashed line in FIG. 7. When two users interact with one or more of the same virtual experiences in the past N days (e.g., 28 days) or when there is an explicit friend connection between two users that interact with one or more of the same virtual experiences, the candidate generator module 202 adds an edge between the two corresponding user nodes, which is illustrated with a solid line in FIG. 7.

The weights for the edges in the graph represent the strength between nodes, but the factors are different depending on the type of node. The edges between the user nodes reflect the duration of interactions with the virtual experiences or an interaction count of the same virtual experience. The edges between a user node and a virtual experience node reflects the user affinity (i.e., engagement) with respect to the virtual experience.

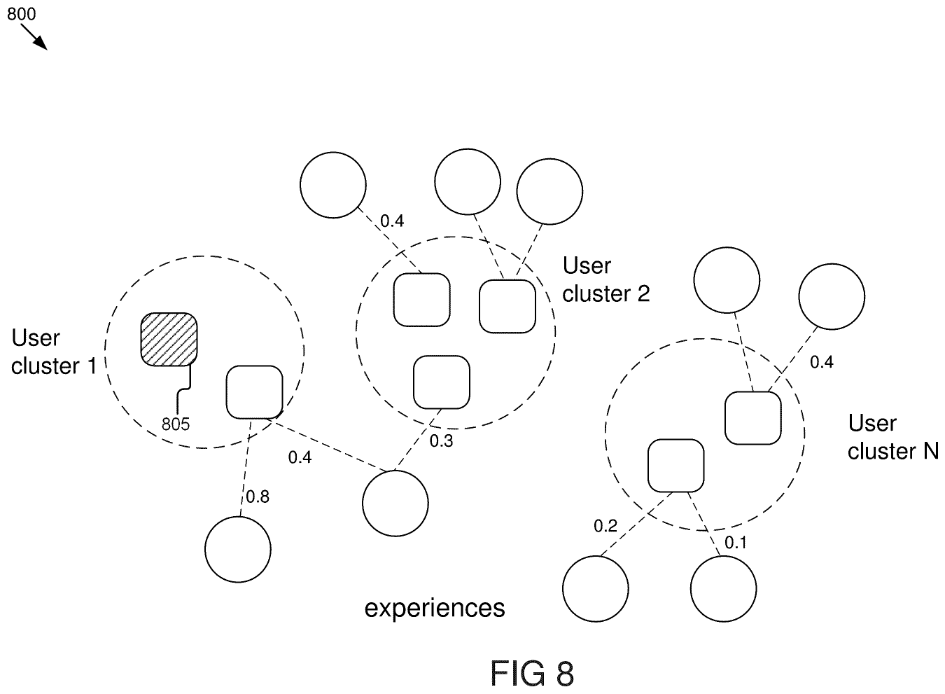

FIG. 8 is a block diagram 800 of example user clusters based on user embeddings. In this example, the candidate generator module 202 generates a graph of user nodes and virtual experience nodes based on users interacting with virtual experiences where the edges between the user nodes and the virtual experience nodes are based on user affinity. In some embodiments, the user nodes are clustered based on the distances of user embeddings generated by the candidate generator module 202. FIG. 8 illustrates the user embeddings as user cluster 1, user cluster 2, and user cluster N.

The candidate generator module 202 clusters one or more users based on a distance between the user embedding for the user and the clustered user embeddings. For example, the user embedding may reflect the user's age, gender, location, etc., which is used to associate the user with the appropriate cluster. User node 805 represents a user with limited user engagement. In some embodiments, the user node 805 is clustered with user cluster 1 based on commonality in the user embeddings. As a result of the clustering, the candidate generator module 202 may recommend similar experiences to user node 805 as the candidate generator module 202 would recommend to other user nodes in user cluster 1. In some embodiments, due the large size of the data set, the candidate generator module 202 generates the user clusters offline.

Once the machine-learning model for the candidate generator module 202 is trained, the machine-learning model receives user features associated with a user as input. The machine-learning model generates a user embedding based on the user features and performs a dot product between the vectors for the user embeddings and the vectors for the already generated item embeddings. The machine-learning model performs an approximate neighbor search to determine the candidate virtual experiences that best correspond to the user features. In some embodiments where the candidate generator module 202 includes multiple candidate generators, the candidate generator module 202 may select a top N number of candidate virtual experiences based on the results from the multiple candidate generators. For example, a first candidate generator includes a user-experience-experience graph, a second candidate generator includes clustered experiences, a third candidate generator includes a users-users-experience graph, and a fourth candidate generator includes clustered users. The candidate generator module 202 may provide a query to each of the candidate generators, receive candidate virtual experiences, and provide the top N number of virtual experiences to the candidate ranker module 204 for ranking.

The candidate ranker module 204 ranks the recommended virtual experiences for a user. In some embodiments, the candidate ranker module 204 includes a set of instructions executable by the processor 235 to rank the recommended virtual experiences. In some embodiments, the candidate ranker module 204 is stored in the memory 237 of the computing device 200 and can be accessible and executable by the processor 235.

In some embodiments, the candidate generator module 202 trains a first machine-learning model to generate candidate virtual experiences and the candidate ranker module 204 trains a second machine-learning model to rank a subset of candidate virtual experiences. The second machine-learning model is hereafter referred to as the machine-learning model in association with the candidate ranker module 204 for ease of explanation. The machine-learning model is trained to rank the candidate virtual experiences. In some embodiments, the recommender model is optimized to rank the candidate virtual experiences based on a particular attribute, such as a longest play time by the user, a likelihood that the user will spend money in association with the experience, etc.

In some embodiments, the candidate ranker module 204 receives item clusters and/or user clusters from the candidate generator module 202. The candidate ranker module 204 may apply transfer learning by advantageously reusing the candidate generator module 202. In addition, the candidate ranker module 204 may take advantage of domain adaption by using clustering algorithms to adopt the embedding features for the metrics that are being optimized.

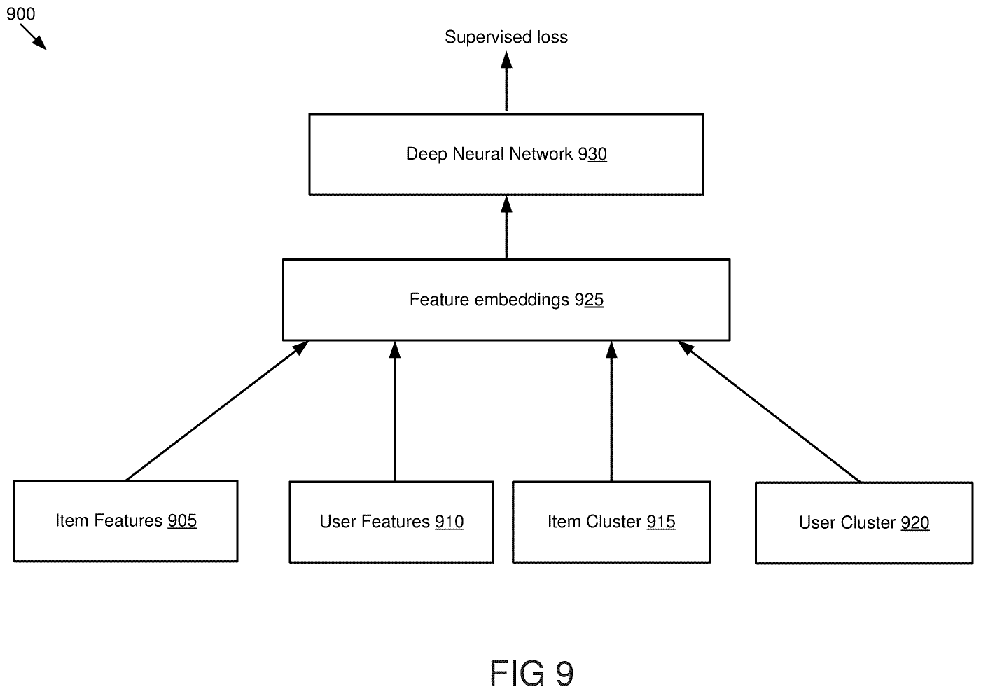

FIG. 9 is a block diagram of an example architecture 900 of the candidate ranker module 204 to rank the candidate virtual experiences. The architecture 900 includes item features 905, user features 910, item clusters 915, and user clusters 920. In some embodiments, the item features 905 and the user features 910 that are provided to the candidate ranker module 204 are different from the item features and user features provided to the candidate generator module 202.

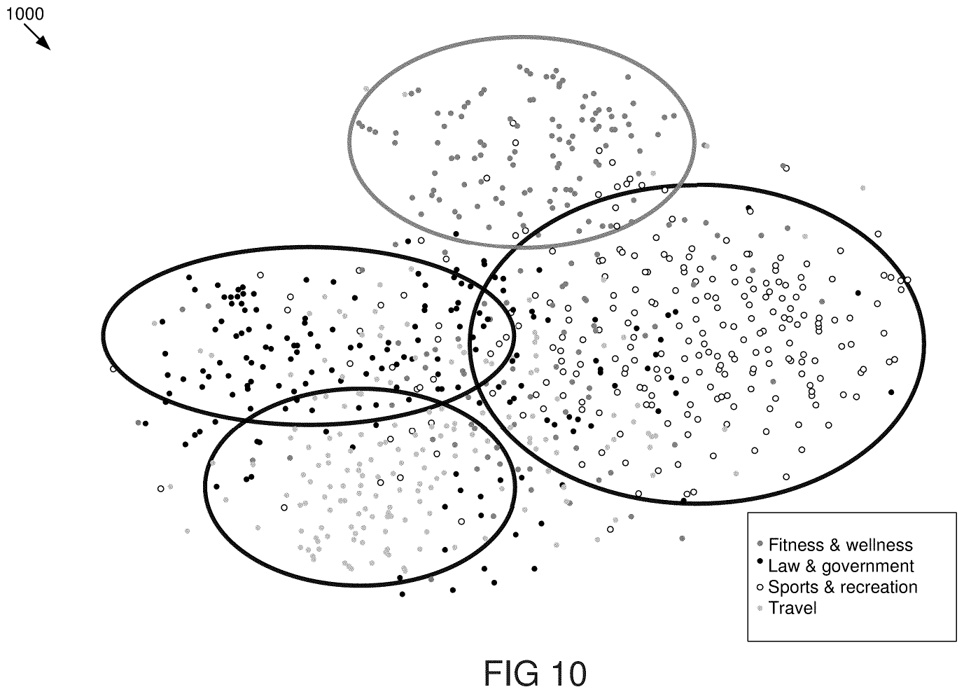

The item clusters 915 and the user clusters 920 are received from the candidate generator module 202. The user clusters 920 represent different user groups and different user interests. Each user may be associated with one or more cluster IDs that represent the user's preferences as user features for the ranking stage. A user's past user-item interaction history may be embodied by cluster IDs of past interacted items to represent a user's interaction history and preferences. Each virtual experience may be associated with one or more cluster IDs that represent different characteristics as explained in greater detail below with reference to FIG. 10.

The candidate ranker module 204 generates feature embeddings 925 from the item features 905, user features 910, item clusters 915, and user clusters 920. The item features 905 describe user interactions with virtual experiences, such as clickthrough rates and interaction times. The user features 910 describe information about the user, such as age, gender, and location.

The item features 905, the user features 910, the item clusters 915, and the user clusters 920 are learned together and not independently as was illustrated in FIG. 4 with respect to the candidate generator module 202. Although item embeddings and user embeddings could be used as dense input for ranking models, the item clusters 915 and the user clusters 920 provide more information about a user or an item than a fixed embedding because the cluster IDs associated with the item clusters 915 and the user clusters 920 can be mapped to a new embedding space within the reranked model and are learned with the item features 905 and the user features 910.

The DNN 930 is trained based on the feature embeddings 925. In some embodiments, the hidden layers in the DNN 930 are crossed, which results in the DNN learning a cross between item features 905 and user features 910.

The supervised loss illustrated in FIG. 9 represents data that is positively labeled or negatively labeled based on a user action. For example, when a user clicks on a candidate virtual experience, the candidate virtual experience is associated with a positive label. When a user does not click on another candidate virtual experience or explicitly rejects the candidate virtual experience, the candidate virtual experience is associated with a negative label.

FIG. 10 is a block diagram 1000 of example item clustering. Each cluster can be generalized as having a particular concentration of item embeddings. Each cluster is associated with a unique cluster ID. In this example, there are four item clusters where the dark gray dots correspond to virtual experiences that include fitness and wellness, the black dots correspond to virtual experiences that include law and government, the white dots correspond to virtual experiences that include sports and recreation, and the light gray dots correspond to virtual experiences that include travel.

The different item clusters are overlapping. For example, if a virtual experience is a game, the game may be categorized in the item embedding as being part of both fitness and wellness cluster, as well as the sports and recreation cluster if the game involves active movement. In another example, if the virtual experience is an action movie about crime in Europe, the virtual experience may be categorized in the item embedding by both the travel cluster and law and government cluster. While these examples are human-understandable examples, persons of ordinary skill in the art will understand that the clusters may involve different machine-learning ways of categorizing item embeddings. A vector of item cluster IDs may be used to represent the user's past interaction history. For example, the user may be associated with two out of the four cluster IDs in FIG. 10.

In some embodiments, the candidate ranker module 204 trains the machine-learning model to output a ranked subset of the candidate virtual experiences to recommend to the user. In some embodiments, machine-learning model receives, as input, a particular feature, such as the top virtual experience where a user is expected to play the longest, the top virtual experiences where the user is expected to spend the most money on purchases, the top virtual experience based on the current time of day, etc. The candidate ranker module 204 may identify which item clusters are closest to the user embedding and rank the candidate virtual experiences based on the comparison. As a result, the ranked subset of the candidate virtual experiences are the virtual experiences that are most likely to satisfy the input, such as the virtual experiences where the user is most likely to spend the most money.

The user interface module 206 generates a user interface for users 125 associated with user devices 115. The user interface may be used to display a user interface that includes one or more recommended virtual experiences for a user. The user interface may also include options for selecting the one or more recommended virtual experiences. In some embodiments, the user interface includes options for modifying options associated with the metaverse, such as options for configuring a user profile to include user preferences.

In some embodiments, once the candidate generator module 202 trains a first machine-learning model, the candidate generator module 202 provides first user features for a first user as input to the first machine-learning model. The first machine-learning model outputs candidate virtual experiences. In some embodiments, the candidate virtual experiences are provided as input to a second machine-learning model trained by the candidate ranker module 204. The second machine-learning model outputs a ranked subset of the candidate virtual experiences. The user interface module 201 generates graphical data for displaying a user interface that includes the ranked subset of the candidate virtual experiences. The user interface is provided to the user.

In some embodiments, before a user participates in the metaverse, the user interface module 206 generates a user interface that includes information about how the user's information is collected, stored, and analyzed. For example, the user interface requires the user to provide permission to use any information associated with the user. The user is informed that the user information may be deleted by the user, and the user may have the option to choose what types of information are provided for different uses. The use of the information is in accordance with applicable regulations and the data is stored securely. Data collection is not performed in certain locations and for certain user categories (e.g., based on age or other demographics), the data collection is temporary (i.e., the data is discarded after a period of time), and the data is not shared with third parties. Some of the data may be anonymized, aggregated across users, or otherwise modified so that specific user identity cannot be determined.

Example Methods

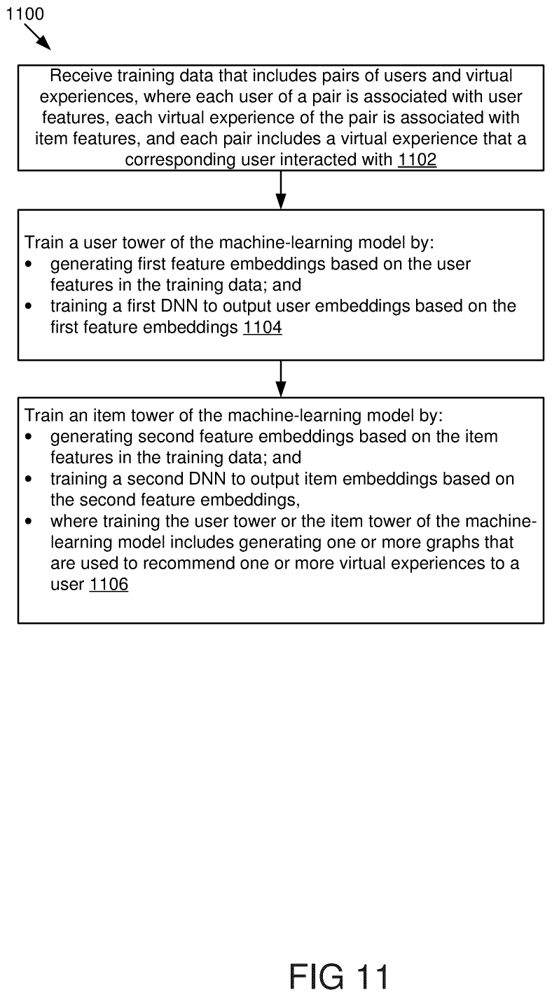

FIG. 11 is a flow diagram of an example method to train a machine-learning model to recommend virtual experiences. In some embodiments, the method 1100 is performed by the metaverse engine 103 stored on the server 101 in FIG. 1.

The method 1100 may begin at block 1102. At block 1102, training data is received that includes pairs of users and virtual experiences, where each virtual experience of the pair is associated with item features and each pair includes a virtual experience that a corresponding user interacted with. Block 1102 may be followed by block 1104.

At block 1104, a user tower of the machine-learning model is trained by: generating feature embeddings based on the user features in the training data and training a first DNN to output user embeddings based on the feature embeddings. Block 1104 may be followed by block 1106.

At block 1106, an item tower of the machine-learning model is trained by: generating feature embeddings based on the item features in the training data and training a second DNN to output item embeddings based on the feature embeddings, where training the user tower or the item tower of the machine-learning model includes generating one or more graphs that are used to recommend one or more virtual experiences to a user.

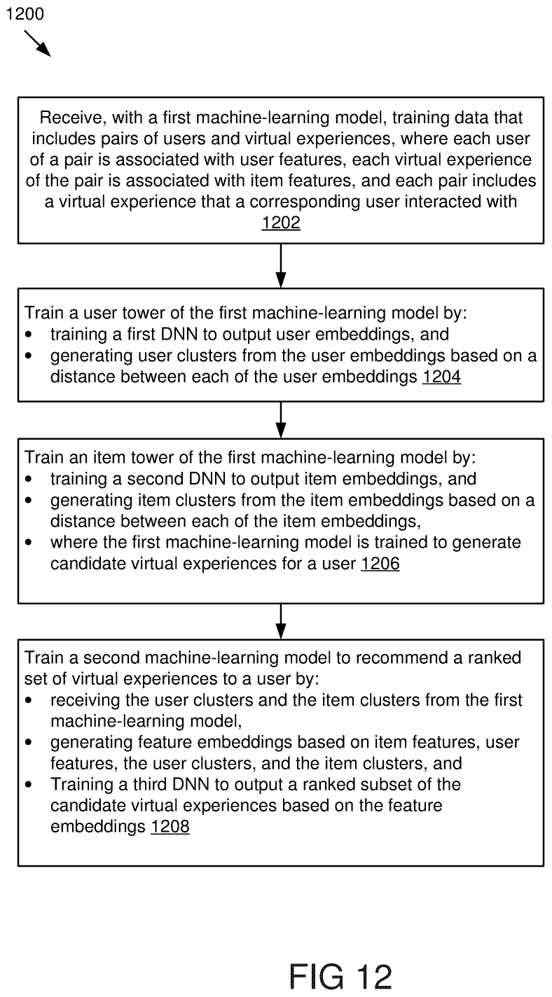

FIG. 12 is a flow diagram of an example method to train a first machine-learning model to recommend virtual experiences and to train a second machine-learning model to rank the virtual experiences. In some embodiments, the method 1100 is performed by the metaverse engine 103 stored on the server 101 in FIG. 1.

The method 1200 may begin at block 1202. At block 1202, a first machine-learning model receives training data that includes pairs of users and virtual experiences, where each user of a pair is associated with user features, each virtual experience of the pair is associated with item features, and each pair includes a virtual experience that a corresponding user interacted with. Block 1202 may be followed by block 1204.

At block 1204, a user tower of the first machine-learning model is trained by: training a first DNN to output user embeddings and generating user clusters from the user embeddings based on a distance between each of the user embeddings. Block 1204 may be followed by block 1206.

At block 1206, an item tower of the first machine-learning model is trained by: training a second DNN to output item embeddings and generating item clusters from the item embeddings based on a distance between each of the item embeddings. The first machine-learning model is trained to generate candidate virtual experiences for a user. Block 1206 may be followed by block 1208.

At block 1208, a second machine-learning model is trained to recommend a ranked set of virtual experiences to a user by: receiving the user clusters and the item clusters from the first machine-learning model; generating feature embeddings based on item features, user features, the user clusters, and the item clusters; and training a third DNN to output a ranked subset of the candidate virtual experiences based on the feature embeddings.

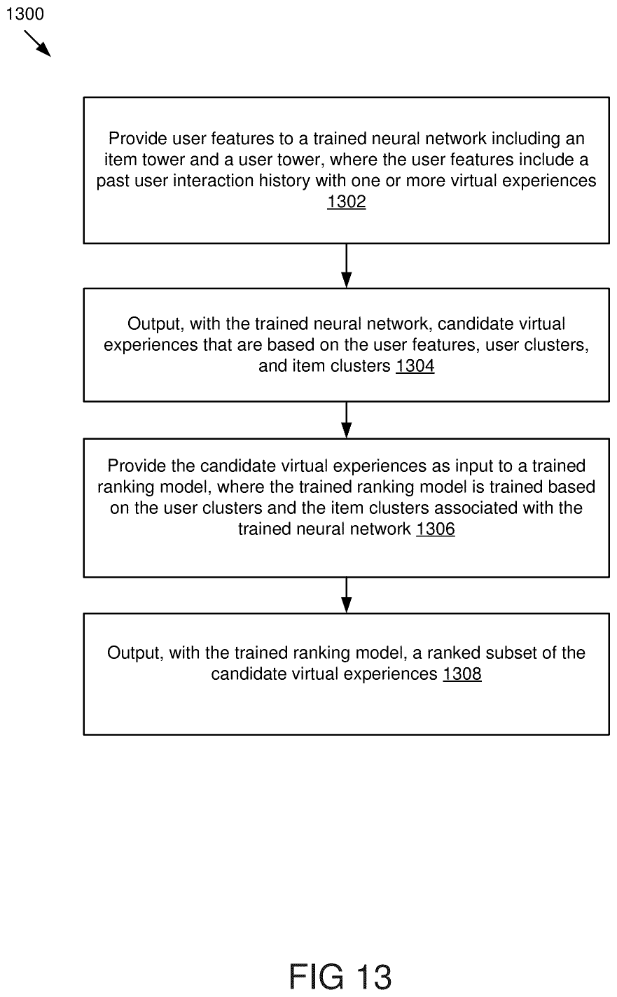

FIG. 13 is a flow diagram of an example method to provide a ranked set of virtual experiences to a user. In some embodiments, the method 1100 is performed by the metaverse engine 103 stored on the server 101 in FIG. 1.

The method 1300 may begin at block 1302. At block 1302, user features are provided to a trained neural network including an item tower and a user tower, where the user features include a past interaction history with one or more virtual experiences. Block 1302 may be followed by block 1304.

At block 1304, the trained neural network outputs candidate virtual experiences that are based on the user features, user clusters, and item clusters. Block 1304 may be followed by block 1306.

At block 1306, the candidate virtual experiences are provided as input to a trained ranking model, where the trained ranking model is trained based on the user clusters and the item clusters associated with the trained neural network. Block 1306 may be followed by block 1308.

At block 1308, the trained ranking model outputs a ranked subset of the candidate virtual experiences.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

Various embodiments described herein include obtaining data from various sensors in a physical environment, analyzing such data, generating recommendations, and providing user interfaces. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., user device only; client+server device; etc.) and where the data analysis is performed (e.g., user device only; client+server device; etc.). Data are utilized for the specific purposes as described herein. No data is shared with third parties without express user permission.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method to train a machine-learning model to recommend candidate virtual experiences to a user, the method comprising:
receiving training data that includes pairs of users and virtual experiences, wherein each user of a pair is associated with user features, each virtual experience of the pair is associated with item features, and each pair includes a virtual experience that a corresponding user interacted with;
training a user tower of the machine-learning model by:
generating first feature embeddings based on the user features in the training data; and
training a first deep neural network (DNN) to output user embeddings based on the first feature embeddings; and
training an item tower of the machine-learning model by:
generating second feature embeddings based on the item features in the training data; and
training a second DNN to output item embeddings based on the second feature embeddings;
wherein training the user tower or the item tower of the machine-learning model includes generating one or more graphs that are used to recommend one or more virtual experiences to a user.

2. The method of claim 1, wherein training the user tower or the item tower of the machine-learning model includes generating a user-experience-experience graph that is formed by:
generating edges between user nodes and virtual experience nodes based on users associated with the user nodes interacting with the virtual experiences associated with the virtual experience nodes, wherein the edges between the user nodes and the virtual experience nodes are based on user affinity; and
generating edges between the virtual experience nodes based on one or more users playing two corresponding virtual experience nodes, wherein the edges between the virtual experience nodes are based on a number of a number of same user actions performed between the two corresponding virtual experience nodes.

3. The method of claim 2, further comprising determining a predicted traversal of the user-experience-experience graph using a random walk algorithm or a Personalized PageRank algorithm.

4. The method of claim 1, wherein training the item tower of the machine-learning model further includes generating item clusters from the item embeddings by:
generating edges between user nodes and virtual experience nodes based on users associated with the user nodes interacting with the virtual experiences associated with the virtual experience nodes, wherein the edges between the user nodes and the virtual experience nodes are based on user affinity;
retrieving one or more virtual experiences with limited user engagement; and
generating the item clusters from the one or more virtual experiences with limited user engagement and corresponding item embeddings based on similarity between the one or more virtual experiences with limited user engagement and the corresponding item embeddings.

5. The method of claim 4, wherein the machine-learning model is a first machine-learning model and further comprising:
training a second machine-learning model to rank a subset of the candidate virtual experiences to recommend to a user, wherein training the second machine-learning model is based on the item clusters.

6. The method of claim 1, wherein training the user tower or the item tower of the machine-learning model includes generating a users-users-experience graph that is formed by:
generating edges between user nodes and virtual experience nodes based on users associated with the user nodes interacting with the virtual experiences associated with the virtual experience nodes, wherein the edges between the user nodes and the virtual experience nodes are based on user affinity; and
generating edges between the user nodes based on users corresponding to the user nodes interacting with one or more same two virtual experiences, wherein the edges between the users are based on a number of same user actions performed between the two corresponding user nodes.

7. The method of claim 1, wherein training the user tower of the machine-learning model further includes generating user clusters from the user embeddings by:
generating edges between user nodes and virtual experience nodes based on users associated with the user nodes interacting with the virtual experiences associated with the virtual experience nodes, wherein the edges between the user nodes and the virtual experience nodes are based on user affinity;
retrieving one or more users; and
generating the user clusters from the one or more users and corresponding item embeddings based on similarities between the one or more users and the corresponding item embeddings.

8. The method of claim 7, wherein the machine-learning model is a first machine-learning model and further comprising:
training a second machine-learning model to rank a subset of the candidate virtual experiences to recommend to a user, wherein training the second machine-learning model is based on the user clusters.

9. The method of claim 8, wherein training the second machine-learning model includes:
generating feature embeddings from the item features, the user features, the item clusters, and the user clusters; and
training a third DNN based on the feature embeddings.

10. The method of claim 1, wherein the user embeddings and the item embeddings are generated offline.

11. A computer-implemented method to recommend a ranked set of virtual experiences to a user, the method comprising:
receiving, with a first machine-learning model, training data that includes pairs of users and virtual experiences, wherein each user of a pair is associated with user features, each virtual experience of the pair is associated with item features, and each pair includes a virtual experience that a corresponding user interacted with;
training a user tower of the first machine-learning model by:
training a first deep neural network (DNN) to output user embeddings; and
generating user clusters from the user embeddings based on a distance between each of the user embeddings;
training an item tower of the first machine-learning model by:
training a second DNN to output item embeddings; and
generating item clusters from the item embeddings based on a distance between each of the item embeddings;
wherein the first machine-learning model is trained to generate candidate virtual experiences for a user; and
training a second machine-learning model to recommend a ranked set of virtual experiences to a user by:
receiving the user clusters and the item clusters from the second machine-learning model;
generating feature embeddings based on item features, user features, the user clusters, and the item clusters; and
training a third DNN to output a ranked subset of the candidate virtual experiences based on the feature embeddings.

12. The method of claim 11, wherein the user clusters are further based on:
generating edges between user nodes and virtual experience nodes based on users associated with the user nodes interacting with the virtual experiences associated with the virtual experience nodes, wherein the edges between the user nodes and the virtual experience nodes are based on user affinity;
retrieving one or more virtual experiences with limited user engagement; and
generating the item clusters from the one or more virtual experiences with limited user engagement and corresponding item embeddings based on similarity between the one or more virtual experiences with limited user engagement and the corresponding item embeddings.

13. The method of claim 11, wherein the item clusters are further based on:
generating edges between user nodes and virtual experience nodes based on users associated with the user nodes interacting with the virtual experiences associated with the virtual experience nodes, wherein the edges between the user nodes and the virtual experience nodes are based on user affinity;
retrieving one or more users; and
generating the user clusters from the one or more users and corresponding item embeddings based on similarities between the one or more users and the corresponding item embeddings.

14. The method of claim 11, wherein training the user tower or the item tower of the first machine-learning model includes generating a user-experience-experience graph that is formed by:
generating edges between user nodes and virtual experience nodes based on users associated with the user nodes interacting with the virtual experiences associated with the virtual experience nodes, wherein the edges between the user nodes and the virtual experience nodes are based on user affinity; and
generating edges between the virtual experience nodes based on one or more users playing two corresponding virtual experience nodes, wherein the edges between the virtual experience nodes are based on a number of a number of same user actions performed between the two corresponding virtual experience nodes.

15. The method of claim 11, wherein training the user tower or the item tower of the first machine-learning model includes generating a users-users-experience graph that is formed by:
generating edges between user nodes and virtual experience nodes based on users associated with the user nodes interacting with the virtual experiences associated with the virtual experience nodes, wherein the edges between the user nodes and the virtual experience nodes are based on user affinity; and
generating edges between the user nodes based on users corresponding to the user nodes interacting with one or more same two virtual experiences, wherein the edges between the users are based on a number of same user actions performed between the two corresponding user nodes.

16. A recommendation system comprising:
one or more processors; and
a memory coupled to the one or more processors, with instructions stored thereon that, when executed by the one or more processors, cause the one or more processors to perform operations comprising:
providing user features to a trained neural network including an item tower and a user tower, wherein the user features include a past user interaction history with one or more virtual experiences;
outputting, with the trained neural network, candidate virtual experiences that are based on the user features, user clusters, and item clusters;
providing the candidate virtual experiences as input to a trained ranking model, wherein the trained ranking model is trained based on the user clusters and the item clusters associated with the trained neural network; and
outputting, with the trained ranking model, a ranked subset of the candidate virtual experiences.

17. The recommendation system of claim 16, wherein the operations further include:
receiving a query that includes the user features; and
generating user vectors based on the user features, wherein outputting the candidate virtual experiences includes performing a nearest-neighbor search of the user vectors to the item clusters.

18. The recommendation system of claim 17, wherein the item clusters include the one or more virtual experiences with limited user engagement and corresponding item embeddings based on similarity between the one or more virtual experiences with limited user engagement and the corresponding item embeddings.

19. The recommendation system of claim 16, wherein the operations further include:
receiving a query that includes the user features associated with a user; and
determining a similarity between the user features and cluster identifiers, wherein outputting the ranked subset of the candidate virtual experiences is based on the cluster identifiers.

20. The recommendation system of claim 19, wherein the cluster identifiers represent a past interaction history of the user.
